(19) United States
(12) Patent Application Publication
(10) Pub. No.: US 2025/0029047 A1
(43) Pub. Date: Jan. 23, 2025

(54) DATA SIMULATION SYSTEM AND METHOD THEREOF

(71) Applicants: Digiwin Software Co., Ltd, Shanghai (CN); DATA SYSTEMS CONSULTING CO., LTD., New Taipei City (TW)

(72) Inventors: Rongjun Shi, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/460,618

(22) Filed: Sep. 4, 2023

(30) Foreign Application Priority Data
Jul. 20, 2023 (CN) 202310897599.2

(51) Int. Cl. G06Q 10/067

(52) U.S. Cl. CPC G06Q 10/067

(57) ABSTRACT

The disclosure provides a data simulation system and a data simulation method. The data simulation system includes an execution engine and a database. The execution engine includes a type matcher, an executor, and an analyzer. The type matcher receives a simulation command and generates a simulation logic group according to a simulation type in the simulation command. The executor executes simulation processing on data according to the simulation logic group to generate a simulation result. The analyzer determines a matching degree between the simulation result and a preset result according to the simulation type. When the matching degree is less than a threshold value, the analyzer adjusts the simulation logic group and commands the executor to execute the simulation processing repeatedly. When the matching degree is greater than the threshold value, the analyzer stores the simulation logic group.

### CROSS-REFERENCE TO RELATED APPLICATION

This application claims the priority benefit of China application serial no. 202310897599.2, filed on Jul. 20, 2023. The entirety of the above-mentioned patent application is hereby incorporated by reference herein and made a part of this specification.

### BACKGROUND

### Technical Field

The disclosure relates to an execution method of establishing a simulation logic and an algorithm in a system, and particularly relates to a data simulation system and a method thereof.

### Description of Related Art

Before being used as a data simulation device providing establishing enterprise (business) services, it usually requires a design personnel to have considerable experience and knowledge of the process and process parameters of the enterprise. However, the data processing process designed by each design personnel cannot be clearly displayed through the change of the actual data, resulting in the inability to effectively store the experience and process design into the system, causing a lot of manpower and time costs consumed for each establishment of the simulation process and the simulation logic.

### SUMMARY

The disclosure is directed to a data simulation system and a method thereof, which can automatically perform a data simulation process and determining a simulation result according to a simulation type and data source information, so as to automatically generate a corresponding simulation logic group.

According to an embodiment of the disclosure, the data simulation system of the disclosure includes an execution engine and a database. The execution engine includes a type matcher, an executor, and an analyzer. The type matcher receives a simulation command and generates a simulation logic group according to a simulation type in the simulation command. The executor executes simulation processing on data according to simulation logic group to generate a simulation result. The analyzer determines a matching degree between the simulation result and a preset result according to the simulation type. When the matching degree is less than a threshold value, the analyzer adjusts the simulation logic group and commands the executor to execute the simulation processing repeatedly. When the matching degree is greater than the threshold value, the analyzer stores the simulation logic group.

According to an embodiment of the disclosure, the data simulation method of the disclosure includes the following. A simulation command is received. A simulation logic group is generated according to a simulation type in the simulation command. Simulation processing is executed on data according to the simulation logic group to generate a simulation result. A matching degree between the simulation result and a preset result is determined according to the simulation type. When the matching degree is less than a threshold value, the simulation logic group is adjusted, and the simulation processing is repeatedly executed.

Based on the above, the data simulation system and the method thereof of the disclosure can automatically establish the corresponding simulation logic group through inputting the simulation command including the simulation type, and automatically perform simulation result determining processing. In this way, the data simulation system and the method thereof of the disclosure can generate the simulation logic group conforming to the default/preset result according to the simulation result determining process, and store the simulation logic group in the system.

In order to make the above-mentioned features and advantages of the disclosure more comprehensible, the following specific embodiments are described in detail together with the accompanying drawings.

### BRIEF DESCRIPTION OF THE DRAWINGS

FIG. 1 is a schematic circuit diagram of a data simulation system according to an embodiment of the disclosure.

FIG. 2 is a flow chart of a data simulation method according to an embodiment of the disclosure.

FIG. 3 is a schematic execution diagram of an execution engine according to an embodiment of the disclosure.

FIG. 4 is a schematic diagram of a design engine according to an embodiment of the disclosure.

FIG. 5 is an exemplary diagram of a processing logic according to an embodiment of the disclosure.

FIG. 6 is a schematic architecture diagram of a simulation design platform and a mechanism simulation execution platform according to an embodiment of the disclosure.

### DESCRIPTION OF THE EMBODIMENTS

Reference will now be made in detail to the exemplary embodiments of the disclosure, examples of which are illustrated in the accompanying drawings. Wherever possible, the same reference numerals are used in the drawings and descriptions to refer to the same or like parts.

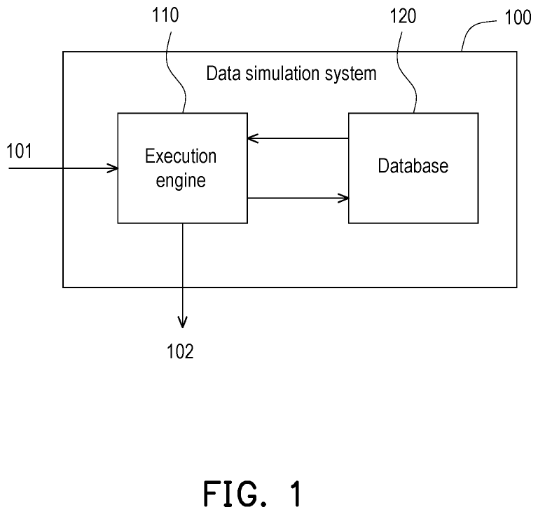

FIG. 1 is a schematic circuit diagram of a data simulation system according to an embodiment of the disclosure. Referring to FIG. 1, a data simulation system 100 includes an execution engine 110 and a design engine. The design engine includes a database 120. The database 120 is coupled to the execution engine 110. In an embodiment, the data simulation system 100 is a simulation logic group 102 configured to develop and adjust simulation data. The simulated data may be parameters and settings of an enterprise resource planning (ERP) system. The data simulation system 100 may be installed in a system development platform or a system, and may also be installed in a local server inside the enterprise to receive a simulation command 101 of a user.

In this embodiment, the execution engine 110 and the design engine may include, for example, a central processing unit (CPU), or other programmable general-purpose or special-purpose microprocessors, a digital signal processor (DSP), an application specific integrated circuit (ASIC), a programmable logic device (PLD), other similar processing circuits, or a combination of the devices. In an embodiment, the execution engine 110 and the design engine may also include a storage device/the database 120, and the database 120 stores the plurality of simulation logic groups 102, a plurality of processing logics, a label comparison table, and a logic comparison table. The database 120 may include a memory and/or a database, in which the memory may be, for example, a non-volatile memory (NVM). The plurality of simulation logic groups 102 stored in the database 120 are a plurality of preset processing logic groups and processing logic sequences. The label comparison table includes labels corresponding to a plurality of simulation types, and simulation data corresponding to the plurality of labels respectively, to provide the executor to perform simulation processing according to the labels corresponding to the simulation types and the plurality of processing logics. In this way, the execution engine 110 may obtain a related program, module, system, or algorithm with the same label from the database 120 through the label corresponding to the simulation type, so that the user can execute the related function and operation of data simulation. In this embodiment, the execution engine 110 and the design engine may be realized by JSON (JavaScript Object Notation), Extensible Markup Language (XML), or YAML and the like, but the disclosure is not limited thereto.

In this embodiment, the user may execute the data simulation system 100 through, for example, a personal computer device, and input the simulation command 101 into the execution engine 110. Specifically, the user may display descriptive information of the plurality of simulation types through the personal computer, so as to fill the simulation commands 101 into a plurality of simulation type fields correspondingly. Next, the execution engine 110 inputs the simulation command 101 and the simulation type and data source information in the simulation command 101 to a type matcher, so that the type matcher obtains the corresponding simulation logic group 102 from the database 120 according to the simulation command 101. The executor then executes simulation on data to generate a simulation result. Then, an analyzer determines a matching degree between the simulation result and a preset result, so as to output the simulation logic group 102 or adjust the simulation logic group 102 according to a comparison result of the matching degree to complete the data simulation and establishing the simulation logic group 102.

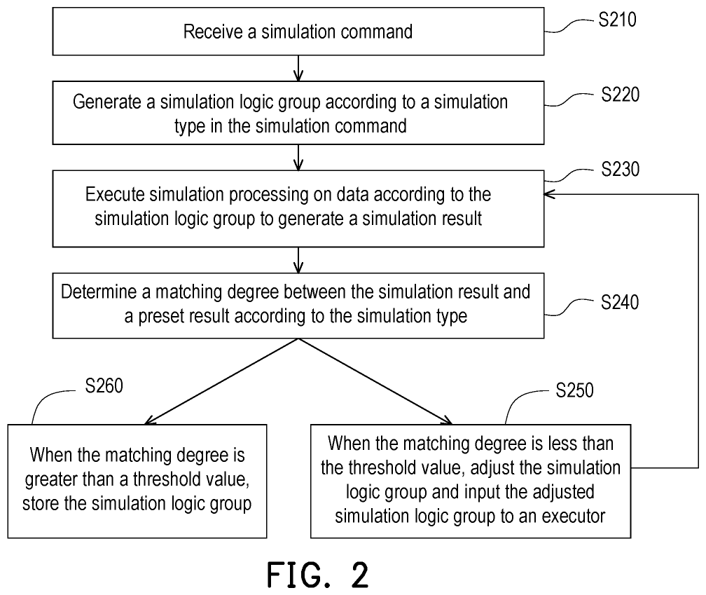

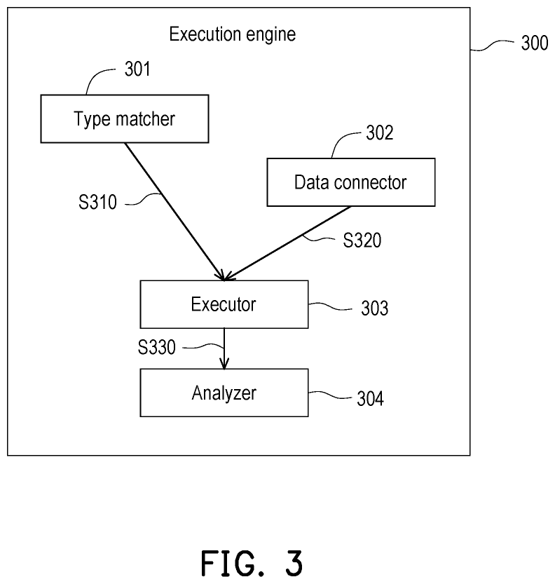

FIG. 2 is a flow chart of a data simulation method according to an embodiment of the disclosure. FIG. 3 is a schematic execution diagram of an execution engine according to an embodiment of the disclosure. Referring to FIG. 1, FIG. 2, and FIG. 3, the data simulation system 100 may execute the following Steps S210 to S260 to automatically generate the system-executable simulation logic group 102. In this embodiment, the user may input the simulation command 101 to the data simulation system 100 to develop or adjust system data and a data processing algorithm. In Step S210, a type matcher 301 receives the simulation command 101. In Step S220, the simulation logic group 102 is generated according to the simulation type in the simulation command. Specifically, the simulation logic group 102 is an operation combination (for example, a processing operation combination) for data execution processing of a corresponding industry (for example, a business scenario). For example, in a scenario of calculating a reasonable inventory level, the processor may calculate the reasonable inventory level of each product according to a sales volume of each product and a monthly average sales volume of each product through the corresponding simulation logic group 102.

It is worth noting that the data simulation system 100 stores the labels corresponding to each of the simulation types (such as the business scenarios) and stores processing logics (such as quantity addition and parameter comparison) corresponding to each of the labels. In other words, the data simulation system stores an association between the simulation type and the label (i.e., the label comparison table) and an association between the label and the processing logic (i.e., the logic comparison table). In this way, the execution engine 110 executes simulation processing on the data corresponding to the simulation command 101 according to the simulation logic group 102 comprising the plurality of processing logics and then generates the simulation result.

In Step S230, an executor 303 executes the simulation processing on the data according to the simulation logic group 102 to generate the simulation result. For example, the simulation result may be the reasonable inventory level of each of the products. In another embodiment, the simulation result may be a classification result calculated according to the sales volume and the monthly average sales volume, so that the user can quickly know the classification of each of the products, such as a hot-selling product, a stable-selling product, a slow-moving product, or a festive product (sales spike in a particular month).

In Step S240, an analyzer 304 determines the matching degree between the simulation result and the preset result according to the simulation type. Specifically, the analyzer 304 stores the preset result corresponding to each of the simulation types. The preset result may be a preset yield value, a preset classification result, a preset sales volume of a product, a preset profit value, and the like. In an embodiment, the simulation logic group 102 is a combination of program codes comprising a plurality of JSON program codes, but the disclosure is not limited thereto.

In Step S250, when the matching degree is less than a threshold value, the analyzer 304 adjusts the simulation logic group and inputs the adjusted simulation logic group to the executor 303, so that the executor 303 repeatedly executes the simulation processing. Specifically, the analyzer 304 stores a comparison table between the simulation type and an influence factor, so the analyzer 304 may obtain information content of the influence factor according to the simulation type. In this way, the analyzer 304 may adjust the simulation logic group 102 according to the simulation type and the influence factor. Next, the analyzer 304 inputs the adjusted simulation logic group 102 into the executor 303, so that the executor 303 executes the simulation processing of the data again. The influence factor may be a parameter such as a calculation parameter, the number of inventory days, a product minimum sales volume, a warehouse storage capacity, the number of rest working hours.

In Step S260, when the matching degree is greater than the threshold value, the analyzer 304 stores the simulation logic group 102. Specifically, when the matching degree between the simulation result and the preset result is greater than the threshold value, the analyzer 304 stores the simulation logic group, and stores the simulation logic group 102 into a category of the current simulation type. For example, the analyzer 304 marks the simulation logic group as a preset simulation logic group for the current simulation type.

Referring to FIG. 1, FIG. 2, and FIG. 3, the simulation command includes data source information. The data source information may include at least one piece of data acquisition information such as a database address, a user login account, and a login password. The type matcher 301 obtains the corresponding simulation logic group 102 from the database 120 according to the simulation type and inputs the simulation logic group 102 into the executor 303 (Step S310). The execution engine also includes a data connector 302. The executor 303 executing the simulation processing on the data according to the simulation logic group to generate the simulation result includes the following. The data connector 302 obtains the data according to the data source information and then inputs the data into the executor 303 (Step S320) so that the executor 303 may execute the simulation processing on the data. In this way, the executor 303 can execute the simulation processing on the data through a simulation data group to generate the simulation result.

In an embodiment, the analyzer 304 stores a preset result comparison table. In this way, the analyzer 304 obtains the preset result corresponding to the simulation logic group 102 or/and the simulation type according to the preset result comparison table. For example, the simulation result is an output result of the last processing logic (i.e. a processing algorithm) in the simulation logic group 102, but the disclosure is not limited thereto.

In an embodiment, the analyzer 304 obtains at least one of the influence factors of the simulation logic group 102 according to the simulation type. The analyzer 304 adjusts the at least one influence factor in the simulation logic group 102 and inputs the adjusted simulation logic group 102 into the executor 303. Next, the executor 303 repeatedly executes the simulation processing according to the adjusted simulation logic group 102 and repeatedly outputs the simulation result. Specifically, the analyzer 304 stores the at least one influence factor corresponding to each of the simulation types. For example, the simulation type is a product sales forecast simulation, and the influence factor is one of an average consumption per person, a customer age group, a product life cycle, and the like.

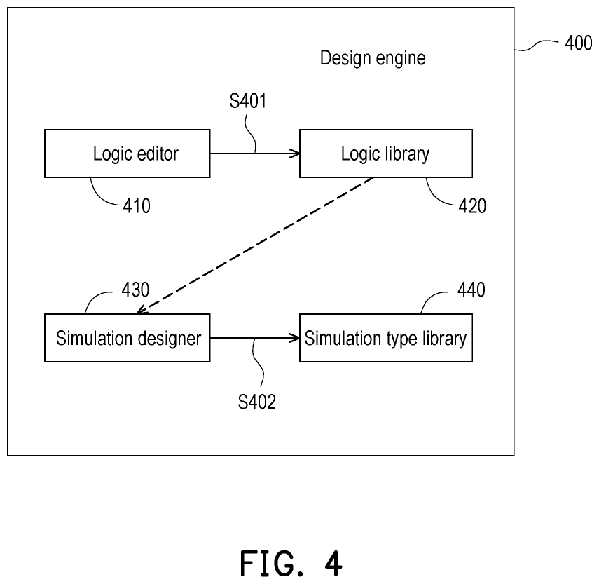

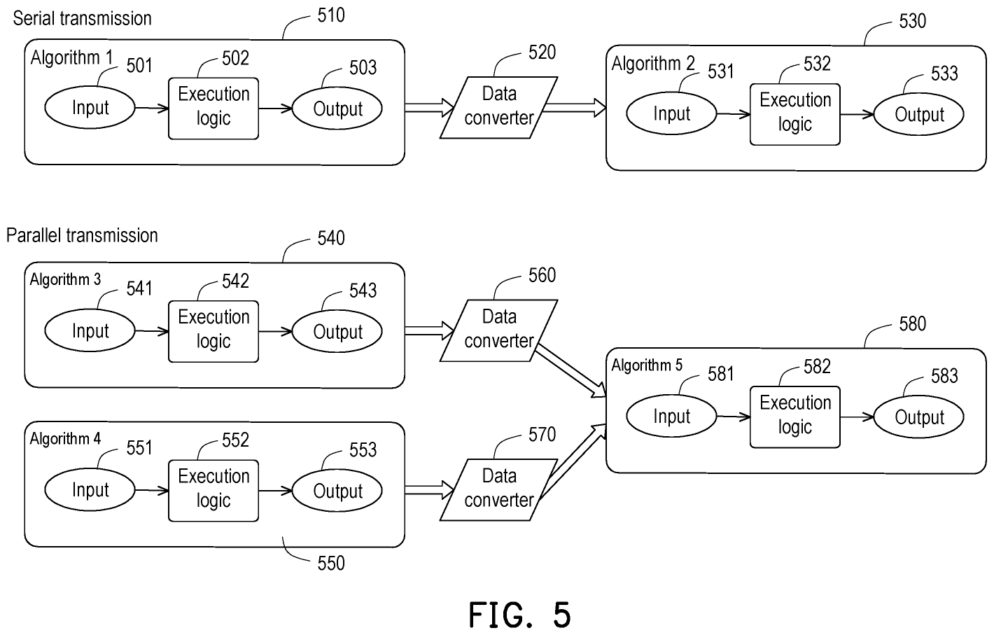

FIG. 4 is a schematic diagram of a design engine according to an embodiment of the disclosure. FIG. 5 is an exemplary diagram of a processing logic according to an embodiment of the disclosure. Referring to FIG. 4 and FIG. 5, the data simulation system 100 also includes a design engine 400. The design engine 400 includes a logic editor 410, a database, and a simulation designer 430. The database 120 includes a logic library 420 and a simulation type library 440. The logic editor 410 receives a design command and then generates a recommended simulation logic group according to the simulation type in the design command. Specifically, a design personnel communicates with the design engine 400 through a computer device and then transmits and receives data and commands from each other. In this way, the design personnel may input the design command into the logic editor 410, so that the logic editor 410 may generate the recommended simulation logic group according to the simulation type and a setting parameter in the design command.

In an embodiment, the logic editor 410 matches the conforming recommended simulation logic group from the logic library 420 according to the simulation type in the design command (Step S401) and displays the recommended simulation logic group on a display for the design personnel to review and examine.

In an embodiment, the simulation designer 430 receives an adjustment command to adjust the recommended simulation logic group and then generates the simulation logic group 102. Also, the simulation designer 430 stores the simulation logic group 102 in the simulation type library 440. Specifically, the adjustment command includes the plurality of processing logics and adjustment information. In this way, the simulation designer 430 converts the recommended simulation logic into the simulation logic according to the plurality of processing logics in the adjustment command and then combines the adjusted simulation logic and the unadjusted recommended simulation logic into the simulation logic group. For example, the adjustment command is a command to perform deleting, adding, changing the sequence, and changing the parameter on the processing logic.

In an embodiment, the logic library 420 stores the label comparison table and the logic comparison table. The label comparison table is a comparison table between each of the simulation types and the plurality of labels. The logic comparison table is a comparison table between the plurality of labels and the plurality of simulation logics. The logic editor 410 obtains the corresponding label according to the simulation type and the label comparison table and then generates the recommended simulation logic group according to the label and the logic comparison table. For example, calculating a reasonable inventory level (i.e., a simulation type) corresponds to an inventory label and a calculating reasonable value label. Then, from the logic comparison table, the simulation logic corresponding to the inventory label including reading a current product list (processing logic), obtaining the volume and weight of each product (processing logic), obtaining the storage condition of each product data (processing logic) from the database (such as an external product database), and calculating the reasonable inventory level of each product according to the obtained parameters (processing logic). In an embodiment, the simulation type is simulation description information, and the simulation description information corresponds to different business scenarios (such as a product manufacturing scenario and an inventory management scenario) and different execution goals (such as calculating inventory level and calculating sales). In this way, the simulation designer 430 may obtain the corresponding simulation logic group from the logic library 420 through the simulation type, and the simulation logic group includes the plurality of processing logics and the sequence between the processing logics.

In an embodiment, the logic editor 410 receives a label adjustment command and then adjusts the logic comparison table according to the label adjustment command. For example, the logic editor 410 modifies the simulation type or the processing logic corresponding to the label in the label comparison table or the logic comparison table according to the label adjustment command.

In an embodiment, the recommended simulation logic group includes a plurality of recommended processing logics. The simulation designer 430 may obtain the plurality of recommended processing logics corresponding to the adjustment command according to the adjustment command. The simulation designer 430 adjusts the plurality of recommended processing logics according to the adjustment command to generate the plurality of processing logics. The simulation designer 430 combines the plurality of processing logics and the plurality of recommended processing logics to generate the simulation logic group. In another embodiment, the design personnel may input a confirmation command to the simulation designer 430 after reviewing the recommended simulation logic group, so that the simulation designer 430 uses the current recommended simulation logic group as the simulation logic group and store in the simulation type library 440.

In an embodiment, the logic library 420 stores the plurality of recommended processing logics and the plurality of data converters. It should be noted that the recommended simulation logic group is a combination of the plurality of recommended processing logics and the plurality of corresponding data converters. Similarly, the simulation logic group comprises the plurality of processing logics and the plurality of corresponding data converters. As shown in FIG. 5, a processing logic 510 (i.e., an algorithm 1) includes input data 501, an execution logic 502, and output data 503. A processing logic 530 (i.e., an algorithm 2) includes input data 531, an execution logic 532, and output data 533. A processing logic 540 (i.e., an algorithm 3) includes input data 541, an execution logic 542, and output data 543. A processing logic 550 (i.e., an algorithm 4) includes input data 551, an execution logic 552, and output data 553. A processing logic 580 (i.e., an algorithm 5) includes input data 581, an execution logic 582, and output data 583. Each of the processing logics includes the input data, the execution logic, and the output data. A serial simulation logic comprises the processing logic 510 (i.e., the algorithm 1), a data converter 520, and the processing logic 530 (i.e., the algorithm 2). In this embodiment, the data converter is configured to convert the output data of the at least one recommended processing logic of the plurality of recommended processing logics into the input data conforming to a next processing operation. A parallel simulation logic is connected to a data converter 560 and a data converter 570 by the processing logic 540 (i.e., the algorithm 3) and the processing logic 550 (i.e., the algorithm 4), and then the data converter 560 and the data converter 570 are connected to the processing logic 580 (i.e., the algorithm 5).

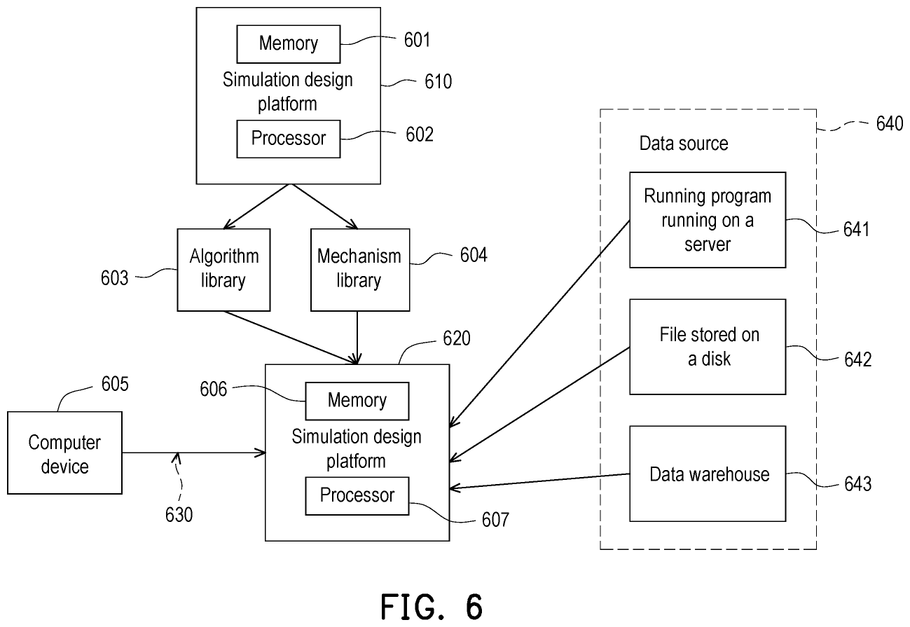

FIG. 6 is a schematic architecture diagram of a simulation design platform and a mechanism simulation execution platform according to an embodiment of the disclosure. The logic library 420 and the simulation type library 440 are coupled to the execution engine. In this way, the type matcher matches the corresponding simulation logic group from the simulation type library 440 according to the simulation type. Next, the type matcher obtains the plurality of processing logics corresponding to a simulation recommendation group from the logic library 420 according to the simulation recommendation group. As shown in FIG. 6, the user may input a simulation command 630 to a mechanism simulation execution platform 620 (i.e., the execution engine) through a computer device 605. Next, the mechanism simulation execution platform obtains corresponding data from a data source 640 according to a mechanism type (i.e., the simulation type) and the data source information in the simulation command 630. The data source 640 may include a running program running on a server 641, a file stored on a disk 642, and a data warehouse 643.

Referring to FIG. 6, a simulation design platform 610 (i.e., the design engine) includes a processor 602 and a memory 601. The mechanism simulation execution platform 620 includes a processor 607 and a memory 606. Moreover, the data simulation system includes an algorithm library 603 and a mechanism library 604, the algorithm library 603 and the mechanism library 604 are both coupled to the simulation design platform 610 and the mechanism simulation execution platform 620. In this way, the mechanism simulation execution platform 620 may obtain the corresponding simulation logic group from the mechanism library 604 according to the simulation type in the simulation command 630, obtain a definition and detailed information of each of the processing logics in the simulation logic group from the algorithm library 603, and then execute data simulation processing on the data.

In summary, the data simulation system and the method thereof of the disclosure can automatically establish the corresponding simulation logic group through inputting the simulation command including the simulation type, and automatically perform simulation result determining processing. In this way, the data simulation system and the method thereof of the disclosure can generate the simulation logic group conforming to the preset result according to the simulation result determining process, and store the simulation logic group in the system. At the same time, the recommended simulation logic group is generated through the design engine according to the design command, and then the recommended simulation logic group adjusted and designed by the design personnel is converted into the simulation logic group. In this way, the experience and determined result of the design personnel are written into the database through establishing the simulation logic group, thereby reducing labor costs during data simulation and improving the recording of experience and knowledge.

Finally, it should be noted that the above embodiments are only used to illustrate the technical solutions of the disclosure, rather than to limit them. Although the disclosure has been described in detail with reference to the foregoing embodiments, persons skilled in the art should understand that the technical solutions described in the foregoing embodiments may still be modified, or equivalent replacements for some or all of the technical features may be performed. However, these modifications or replacements do not make the essence of the corresponding technical solutions depart from the scope of the technical solutions of the embodiments of the disclosure.

What is claimed is:

1. A data simulation system, comprising:
an execution engine storing a plurality of operation combinations, wherein the execution engine comprises a type matcher, an executor, and an analyzer, wherein the executor is coupled to the type matcher and the analyzer,
wherein the type matcher receives a simulation command, and generates a simulation logic group according to a simulation type in the simulation command,
wherein the executor executes simulation processing on data according to the simulation logic group to generate a simulation result,
wherein the analyzer determines a matching degree between the simulation result and a preset result according to the simulation type,
wherein when the matching degree is less than a threshold value, the analyzer adjusts the simulation logic group, and inputs the simulation logic group, which is adjusted, to the executor, so that the executor repeatedly executes the simulation processing,
wherein when the matching degree is greater than the threshold value, the analyzer stores the simulation logic group.

2. The data simulation system according to claim 1, wherein the simulation command comprises data source information, wherein the execution engine further comprises a data connector,
wherein the data connector obtains the data according to the data source information and then inputs the data into the executor,
wherein the executor executes the simulation processing on the data through a simulation data group to generate the simulation result.

3. The data simulation system according to claim 1, wherein the analyzer stores a preset result comparison table, wherein the analyzer obtains the preset result corresponding to the simulation logic group according to the preset result comparison table.

4. The data simulation system according to claim 1, wherein the analyzer obtains at least one influence factor of the simulation logic group according to the simulation type,
wherein the analyzer adjusts the at least one influence factor in the simulation logic group and inputs the simulation logic group, which is adjusted, into the executor,
wherein the executor repeatedly executes the simulation processing according to the simulation logic group, which is adjusted, and repeatedly outputs the simulation result.

5. The data simulation system according to claim 1, further comprising:
a design engine comprising a logic editor, a database, and a simulation designer, wherein the database comprises a logic library and a simulation type library,
wherein the logic editor receives a design command and then generates a recommended simulation logic group according to the simulation type in the design command,
wherein the simulation designer receives an adjustment command to adjust the recommended simulation logic group and then generates the simulation logic group.

6. The data simulation system according to claim 5, wherein the logic library and the simulation type library are coupled to the execution engine,
wherein the type matcher matches the corresponding simulation logic group from the simulation type library according to the simulation type,
wherein the type matcher obtains a plurality of processing logics corresponding to a simulation recommendation group from the logic library according to the simulation recommendation group.

7. The data simulation system according to claim 5, wherein the recommended simulation logic group comprises a plurality of recommended processing logics, wherein the simulation designer obtains the plurality of recommended processing logics corresponding to the adjustment command according to the adjustment command,
wherein the simulation designer adjusts the plurality of recommended processing logics according to the adjustment command to generate a plurality of processing logics,
wherein the simulation designer combines the plurality of processing logics and the plurality of recommended processing logics to generate the simulation logic group.

8. The data simulation system according to claim 7, wherein the logic library stores the plurality of recommended processing logics and a plurality of data converters,
wherein the recommended simulation logic group is a combination of the plurality of recommended processing logics and the plurality of corresponding data converters,
wherein the plurality of data converters are configured to convert output data of at least one recommended processing logic of the plurality of recommended processing logics into input data conforming to a next processing operation.

9. The data simulation system according to claim 5, wherein the logic library stores a label comparison table and a logic comparison table, wherein the simulation type is simulation description information, and the simulation description information corresponds to different business scenarios and different execution goals respectively,
wherein the logic editor obtains a corresponding label according to the simulation type and the label comparison table and then generates the recommended simulation logic group according to the label and the logic comparison table.

10. The data simulation system according to claim 9, wherein the logic editor receives a label adjustment command and further adjusts the logic comparison table according to the label adjustment command.

11. A data simulation method, comprising:
receiving a simulation command through a type matcher;
generating a simulation logic group according to a simulation type in the simulation command through the type matcher;
executing simulation processing on data through an executor according to the simulation logic group to generate a simulation result; and
determining a matching degree between the simulation result and a preset result through analyzer according to the simulation type,
wherein when the matching degree is less than a threshold value, the analyzer adjusts the simulation logic group, and inputs the simulation logic group, which is adjusted, to the executor, so that the executor repeatedly executes the simulation processing,
wherein when the matching degree is greater than the threshold value, the analyzer stores the simulation logic group.

12. The data simulation method according to claim 11, wherein the simulation command comprises data source information, wherein execution engine comprises a data connector,
wherein the executor executing the simulation processing on the data according to the simulation logic group to generate the simulation result comprises:
obtaining the data according to the data source information through the data connector, and then inputting the data into the executor,
executing the simulation processing on the data through the executor through a simulation data group to generate the simulation result.

13. The data simulation method according to claim 11, wherein the analyzer stores a preset result comparison table,
wherein the analyzer determining the matching degree between the simulation result and the preset result according to the simulation type comprises:
obtaining the preset result corresponding to the simulation logic group through the analyzer according to the preset result comparison table.

14. The data simulation method according to claim 11, wherein the analyzer adjusting the simulation logic group and repeatedly executing the simulation processing comprises:
obtaining at least one influence factor of the simulation logic group according to the simulation type through the analyzer,
adjusting the at least one influence factor in the simulation logic group through the analyzer and inputting the simulation logic group, which is adjusted, into the executor,
executing repeatedly the simulation processing through the executor according to the simulation logic group, which is adjusted, and repeatedly outputting the simulation result.

15. The data simulation method according to claim 11, further comprising:
a design engine comprising a logic editor, a database, and a simulation designer, wherein the database comprises a logic library and a simulation type library,
receiving a design command through the logic editor and then generating a recommended simulation logic group according to the simulation type in the design command; and
receiving an adjustment command through the simulation designer to adjust the recommended simulation logic group and then generating the simulation logic group.

16. The data simulation method according to claim 15, wherein generating the recommended simulation logic group according to the simulation type in the design command comprises:
matching the corresponding simulation logic group from the simulation type library according to the simulation type through the type matcher; and
obtaining a plurality of processing logics corresponding to a simulation recommendation group from the logic library according to the simulation recommendation group through the type matcher.

17. The data simulation method according to claim 15, wherein the recommended simulation logic group comprises a plurality of recommended processing logics, wherein generating the simulation logic group further comprises:
obtaining the plurality of recommended processing logics corresponding to the adjustment command through the simulation designer according to the adjustment command;
adjusting the plurality of recommended processing logics through the simulation designer according to the adjustment command to generate a plurality of processing logics; and
combining the plurality of processing logics and the plurality of recommended processing logics through the simulation designer to generate the simulation logic group.

18. The data simulation method according to claim 17, wherein the logic library stores the plurality of recommended processing logics and a plurality of data converters,
wherein the recommended simulation logic group is a combination of the plurality of recommended processing logics and the plurality of corresponding data converters,
wherein the plurality of data converters are configured to convert output data of at least one recommended processing logic of the plurality of recommended processing logics into input data conforming to a next processing operation.

19. The data simulation method according to claim 15, wherein the logic library stores a label comparison table and a logic comparison table, wherein the simulation type is simulation description information, and the simulation description information corresponds to different business scenarios and different execution goals respectively,
wherein the logic editor receiving the design command and then generating the recommended simulation logic group according to the simulation type in the design command comprises:
obtaining a corresponding label according to the simulation type and the label comparison table through the logic editor and then generating the recommended simulation logic group according to the label and the logic comparison table.

20. The data simulation method according to claim 19, wherein generating the recommended simulation logic group according to the simulation type in the design command further comprises:
receiving a label adjustment command through the logic editor and then adjusting the logic comparison table according to the label adjustment command.
